(19) United States
(12) Patent Application Publication
(10) Pub. No.: US 2005/0110454 A1
(43) Pub. Date: May 26, 2005

(54) Methods and apparatuses for tracking maximum power point of solar electricity generating system

(76) Inventors: Wen-Yin Tsai, Taoyuan Shien (TW); Hung-Liang Chou, Taoyuan Shien (TW); Chin-Chang Wu, Taoyuan Shien (TW); Kuen-Der Wu, Taoyuan Shien (TW); Chun-Li Shu, Taoyuan Shien (TW)

Correspondence Address: Kirton & McConkie;1800 Eagle Gate Tower, 60 East South Temple, P. O. Box 45120, Salt Lake City, UT, 84145-0120, US

(21) Appl. No.: 10/993,861

(22) Filed: Nov. 19, 2004

(30) Foreign Application Priority Data
Nov. 25, 2003 (TW) 92133110

(51) Int. Cl. H02M 3/24

(52) U.S. Cl. 320/101

(57) ABSTRACT

A solar electricity generating system includes a solar cell and a DC/AC converter coupled to the cell. The first proposed method includes the steps of: (a) adjusting an output current of the DC/AC converter; (b) sensing an output voltage variation of the solar cell; (c) adjusting the output current in a direction of the variation; and (d) repeating the steps (a) to (c). The second proposed method includes the steps of: (a) adjusting a DC output voltage of the solar cell; (b) sensing an output current amplitude variation of the DC/AC converter; (c) adjusting the output voltage in a direction of the variation; and (d) repeating the steps (a) to (c).

### FIELD OF THE INVENTION

The present invention relates to the methods and apparatuses for tracking the maximum power point of the solar electricity generating system. More specifically, this invention relates to the methods and apparatuses for tracking the maximum power point of the solar electricity generating system having a solar cell.

### BACKGROUND OF THE INVENTION

Due to the highly developed industries, not only the petrochemical energy source on the earth is gradually dried out, but also the global environment is seriously polluted and changed. To diversify the kinds/sources of the energy and find the sustainable energy sources, solar power is the new energy source having the potential to be further developed except for the petrochemical fuel, the hydroelectric power, and the nuclear electric power. If the solar energy can be employed effectively, not only the problem of finding the new energy sources can be solved, but also the serious situation of the environmental pollution and global warming/green house effect can be improved by using the clean and pollution-free solar energy. According to the estimation, the usage of the solar energy will be increased dramatically in a growing rate of 15% to 35% each year in the next twenty years or so.

The main critical techniques of employing the solar electro-optical energy are the solar cell techniques and the power conversion interface techniques. The critical techniques of the power conversion interface techniques are the maximum power point tracking techniques and the anti-island techniques. Among which, the maximum power point tracking techniques are highly regarded as the very important techniques desired to be improved and lots of efforts have been invested by the industry for improving these techniques.

Among the numerous maximum power point tracking techniques, the perturbation and observation method is the most frequently employed one. As for the representative patents of this method, please refer to the Japan Patent No. 8-44445 and Japan Patent No. 8-44446. In the '445 patent, the maximum power point tracking method and apparatus for periodically measuring the output real power of the solar cell and adjusting the DC output voltage accordingly so as to increase the output real power of the solar cell are proposed. The unique technical feature of the '445 patent is included in the following steps: adjusting the DC output voltage of the solar cell and observing the variation direction of the output real power of the solar cell. If the output real power of the solar cell is increased after the DC output voltage of the solar cell is adjusted, adjust the DC output voltage of the solar cell in the same direction continuously. Otherwise, if the output real power of the solar cell is decreased after the DC output voltage of the solar cell is adjusted, adjust the DC output voltage of the solar cell in the opposite direction. Besides, if the adjustment value of the DC output voltage of the solar cell along the same or the opposite directions has reached a pre-determined value, the voltage difference between two successive adjustments is desired to be smaller and smaller since then.

In the '446 patent, the proposed maximum power point tracking method and device are employed to further express the unmentioned part of the '445 patent. That is, if the output real power of the solar cell is the same after the DC output voltage of the solar cell is adjusted, keep the DC output voltage at the same level.

The above-mentioned two Japan patents completely described the technically features of the perturbation and observation method. However, the output real power of the solar power generating system must be calculated, thus the configuration of the circuit is complex and the costs can not be decreased relatively, and the researchers are all trying very hard to improve these disadvantages.

Keeping the drawbacks of the prior arts in mind, and employing experiments and research full-heartily and persistently, the applicants finally conceived the methods and apparatuses for tracking the maximum power point of the solar electricity generating system.

### SUMMARY OF THE INVENTION

It is therefore an object of the present invention to propose the methods and apparatuses for tracking the maximum power point of the solar electricity generating system through adjusting the output current amplitude of the DC/AC converter and sensing the variation of the output voltage of the solar cell to decide the adjusting direction of the current amplitude for the next round accordingly which can be applied to both of the configurations having a single converter stage or two converter stages so as to achieve the purpose of tracking the maximum output power point of the solar cell without really computing the output real power of the solar electricity generating system.

According to the first aspect of the present invention, the method for tracking a maximum power point of a solar electricity generating system, wherein the system includes a solar cell and a DC/AC converter electrically connected to the cell, includes the steps of: (a) providing an initial value of an output current of the converter; (b) sensing an initial value of an output voltage of the cell in response to the initial value of the output current; (c) providing a reference output current of the converter and allowing the system being operated under the reference output current for a specific time period; (d) sensing a reference output voltage of the cell in response to the reference output current; (e) comparing the reference output voltage with the initial value of the output voltage to generate a variation of the output voltage; (f) adjusting the reference output current in a direction of the variation and replacing the initial value of the output voltage by the reference output voltage; and (g) repeating the steps (c) to (f).

According to the second aspect of the present invention, the method for tracking a maximum power point of a solar electricity generating system, wherein the system includes a solar cell and a DC/AC converter electrically connected to the cell, includes the steps of: (a) adjusting an output current of the converter; (b) sensing an output voltage variation of the cell; (c) adjusting the output current in a direction of the variation; and (d) repeating the steps (a) to (c).

According to the third aspect of the present invention, the apparatus for tracking a maximum power point of a solar electricity generating system, wherein the system includes a solar cell and a DC/AC converter electrically connected to the cell, and an output voltage and an output current are generated by the cell and the converter respectively, includes: a digital processor electrically connected to the cell and the converter for receiving a feedback of the output voltage and a feedback of the output current, and generating a control signal in response to a variation of the output voltage, and a pulse-width modulated (PWM) driver electrically connected to the converter and the processor for generating a PWM signal of the converter in response to the, control signal so as to adjust the output current amplitude in a direction of the variation of the output voltage.

Preferably, the apparatus further includes a capacitor electrically connected to the cell and the converter in parallel.

Preferably, the converter is a DC/AC inverter.

Preferably, the processor includes: a voltage detecting unit for receiving a feedback voltage of a power distribution system electrically connected to the solar electricity generating system and generating a voltage detecting signal, a phase-locked loop control unit for receiving the voltage detecting signal and generating a phase-locked loop signal, a multiplier for multiplying the phase-locked loop signal by a pre-determined output current amplitude and generating a reference signal of the output current accordingly, and a comparator for subtracting the feedback of the output current from the reference signal of the output current so as to generate the control signal.

According to the fourth aspect of the present invention, the apparatus for tracking a maximum power point of a solar electricity generating system, wherein the system includes a solar cell, a DC/DC converter electrically connected to the solar cell, and a DC/AC converter electrically connected to the DC/DC converter, and a first output voltage, a second output voltage, and an output current are generated by the cell, the DC/DC converter, and the DC/AC converter respectively, includes: a digital processor electrically connected to the cell, the DC/DC converter, and the DC/AC converter for receiving a feedback of the second output voltage and a feedback of the output current, and generating a control signal in response to a variation of the second output voltage, and a pulse-width modulated (PWM) driver electrically connected to the processor and both the DC/DC converter and the DC/AC converter for generating PWM signals of the DC/DC converter and the DC/AC converter in response to the control signal so as to generate the second output voltage by the DC/DC converter and adjust an output current amplitude through the DC/AC converter in a direction of the variation of the second output voltage.

Preferably, the DC/DC converter is a boost converter for receiving and boosting the first output voltage to generate the second output voltage.

Preferably, the second output voltage is proportional to the first output voltage with a fixed ratio.

Preferably, the DC/AC converter is a DC/AC inverter.

Preferably, the apparatus further includes a first and a second capacitors, wherein the first capacitor is electrically connected to the cell and the DC/DC converter in parallel, and the second capacitor is electrically connected to the DC/DC and the DC/AC converters in parallel.

Preferably, the processor includes: a voltage detecting unit for receiving a feedback voltage of a power distribution system electrically connected to the solar electricity generating system and generating a voltage detecting signal, a phase-locked loop control unit for receiving the voltage detecting signal and generating a phase-locked loop signal, a multiplier for multiplying the phase-locked loop signal by a pre-determined output current amplitude and generating a reference signal of the output current accordingly, and a comparator for subtracting the feedback of the output current from the reference signal of the output current so as to generate the control signal.

According to the fifth aspect of the present invention, the method for tracking a maximum power point of a solar electricity generating system, wherein the system includes a solar cell and a DC/AC converter electrically connected to the cell, includes the steps of: (a) providing an initial value of a DC output voltage of the cell; (b) sensing an initial value of an output current amplitude of the converter in response to the initial value of the output voltage; (c) providing a reference output voltage of the cell and allowing the system being operated under the reference output voltage for a specific time period; (d) sensing a reference output current amplitude of the converter in response to the reference output voltage; (e) comparing the reference output current amplitude with the initial value of the output current amplitude to generate an amplitude variation of the output current; (f) adjusting the reference output voltage in a direction of the amplitude variation and replacing the initial value of the output current amplitude by the reference output current amplitude; and (g) repeating the steps (c) to (f).

According to the sixth aspect of the present invention, the method for tracking a maximum power point of a solar electricity generating system, wherein the system includes a solar cell and a DC/AC converter electrically connected to the cell, includes the steps of: (a) adjusting a DC output voltage of the cell; (b) sensing an output current amplitude variation of the converter; (c) adjusting the output voltage in a direction of the variation; and (d) repeating the steps (a) to (c).

According to the seventh aspect of the present invention, the apparatus for tracking a maximum power point of a solar electricity generating system, wherein the system includes a solar cell and a DC/AC converter electrically connected to the cell, and an output voltage and an output current are generated by the cell and the converter respectively, includes: a digital processor electrically connected to the cell and the converter for receiving a feedback of the output voltage and a feedback of the output current, and generating a control signal in response to an output current amplitude variation, and a PWM driver electrically connected to the converter and the processor for generating a PWM signal of the DC/AC converter in response to the control signal so as to adjust the output voltage in a direction of the amplitude variation of the output current.

Preferably, the apparatus further includes a capacitor electrically connected to the cell and the converter.

Preferably, the converter is a DC/AC inverter.

Preferably, the processor includes: a voltage detecting unit for receiving a feedback voltage of a power distribution system electrically connected to the solar electricity generating system and generating a voltage detecting signal, a phase-locked loop control unit for receiving the voltage detecting signal and generating a phase-locked loop signal, a first comparator for subtracting the feedback of the output voltage from a pre-determined voltage so as to generate an output voltage error signal, a proportional integral controller for receiving the error signal so as to generate an output current amplitude signal, a multiplier for multiplying the phase-locked loop signal by the amplitude signal and generating an output current reference signal accordingly, and a second comparator for subtracting the feedback of the output current from the reference signal so as to generate the control signal.

According to the eighth aspect of the present invention, the apparatus for tracking a maximum power point of a solar electricity generating system, wherein the system includes a solar cell, a DC/DC converter electrically connected to the solar cell, and a DC/AC converter electrically connected to the DC/DC converter, and a first output voltage, a second output voltage, and an output current are generated by the cell, the DC/DC converter, and the DC/AC converter respectively, includes: a digital processor electrically connected to the cell, the DC/DC converter, and the DC/AC converter for receiving a feedback of the second output voltage and a feedback of the output current, and generating a control signal in response to an output current amplitude variation, and a PWM driver electrically connected to the processor and both the DC/DC converter and the DC/AC converter for generating PWM signals of the DC/DC converter and the DC/AC converter in response to the control signal so as to generate the second output voltage by the DC/DC converter and adjust the first output voltage through the cell in a direction of the amplitude variation of the output current.

Preferably, the DC/DC converter is a boost converter for receiving and boosting the first output voltage to generate the second output voltage.

Preferably, the second output voltage is proportional to the first output voltage with a fixed ratio.

Preferably, the second output voltage has a fixed value.

Preferably, the DC/AC converter is a DC/AC inverter.

Preferably, the apparatus further includes a first and a second capacitors, wherein the first capacitor is electrically connected to the cell and the DC/DC converter in parallel, and the second capacitor is electrically connected to the DC/DC converter and the DC/AC converter in parallel.

Preferably, the processor includes: a voltage detecting unit for receiving a feedback voltage of a power distribution system electrically connected to the solar electricity generating system and generating a voltage detecting signal, a phase-locked loop control unit for receiving the voltage detecting signal and generating a phase-locked loop signal, a first comparator for subtracting the feedback of the second output voltage from a pre-determined voltage so as to generate an output voltage error signal, a proportional integral controller for receiving the error signal so as to generate an output current amplitude signal, a multiplier for multiplying the phase-locked loop signal by the amplitude signal and generating an output current reference signal accordingly, and a second comparator for subtracting the feedback of the output current from the reference signal so as to generate the control signal.

The present invention may best be understood through the following descriptions with reference to the accompanying drawings, in which:

### BRIEF DESCRIPTION OF THE DRAWINGS

FIG. 1 is the block diagram of the solar electricity generating system of the first preferred embodiment of the present invention;

FIG. 2(a) is the flow chart of the first proposed method for tracking the maximum power point of the solar electricity generating system, which adjusts the output current of the DC/AC inverter according to the DC output voltage variation of the solar cell;

FIG. 2(b) is the flow chart of the second proposed method for tracking the maximum power point of the solar electricity generating system, which adjusts the output voltage of the solar cell according to the DC output current variation of the DC/AC inverter;

FIG. 3 is the block diagram of the second preferred embodiment of the solar electricity generating system having a single converter of the present invention;

FIG. 4(a) is the block diagram of the digital processor of the second preferred embodiment of the present invention, which adjusts the output current of the DC/AC inverter according to the DC output voltage variation of the solar cell;

FIG. 4(b) is the block diagram of the digital processor of the second preferred embodiment of the present invention, which adjusts the output voltage of the solar cell according to the DC output current variation of the DC/AC inverter;

FIG. 5 is the block diagram of the third preferred embodiment of the solar electricity generating system having two converters of the present invention;

FIG. 6 is the circuit diagram of the DC/DC converter of the third preferred embodiment of the present invention; and

FIG. 7 is the block diagram, which shows how the digital processor controls the DC/DC converter through the fixed DC output voltage method of the third preferred embodiment of the present invention.

### DETAILED DESCRIPTION OF THE PREFERRED EMBODIMENT

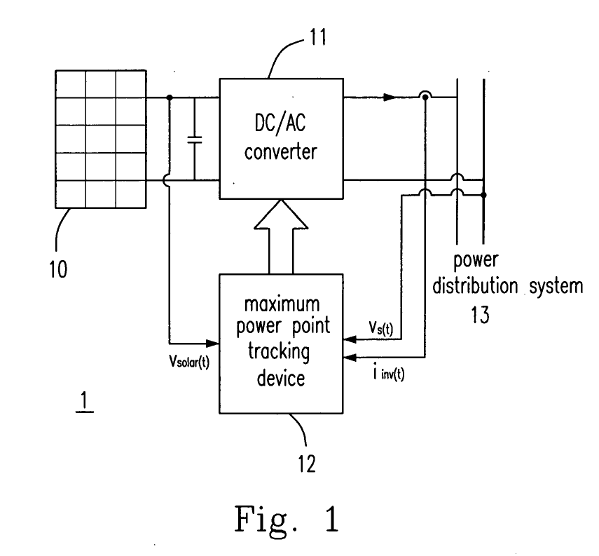

Please refer to FIG. 1, it shows the block diagram of the solar electricity generating system of the first preferred embodiment of the present invention. In which, the solar electricity generating system 1 includes a solar cell 10, a DC/AC converter 11, and a maximum power point tracking device 12 for transforming the solar optical power into an AC electric power and sending the AC electric power to a power distribution system 13. The main differences between the technical features of the proposed maximum power point tracking device 12 and the operational method of the traditional maximum power point tracking device are: there is no need to really calculate the output real power of the solar electricity generating system 1, and the purpose of maximum power point tracking can be achieved through adjusting the output current amplitude of the DC/AC converter 11 in the present invention. The basic principles of the present invention are described as follows.

Assume that the voltage of the power distribution system 13 is:
vₛ(t)=Vₚ sin (wt) (1)

In which, Vₚ is the output voltage amplitude of the power distribution system 13.

Since the output current of the DC/AC converter 11 also has a sinusoidal waveform and the same phase like the voltage of the power distribution system 13, the output current of the DC/AC converter 11 can be expressed as:
iᵢₙᵥ(t)=Iᵢₙᵥ sin (wt) (2)

In which, Iᵢₙᵥ is the output current amplitude of the DC/AC converter 11.

Thus, the output real power of the DC/AC converter 11 can be expressed as:
pᵢₙᵥ(t)=(½)(VₚIᵢₙᵥ) (3)

Besides, the output real power of the solar cell 10 can be expressed as:
pₛₒₗₐᵣ(t)=vₛₒₗₐᵣ(t) iₛₒₗₐᵣ (t) (4)

In which, vₛₒₗₐᵣ(t) is the output voltage of the solar cell 10, and iₛₒₗₐᵣ (t) is the output current of the solar cell 10.

Assume that the DC/AC converter 11 has no power loss, which means that equation (3)=equation (4), thus:

$$\begin{matrix}{p}_{solar} ( t ) = {p}_{inv} ( t ) \\ = {v}_{solar} ( t ) {i}_{solar} ( t ) \\ = ( 1 / 2 ) ( {V}_{p} {I}_{inv} )\end{matrix} \qquad ( 5 )$$

Firstly, the output current of the solar cell 10, iₛₒₗₐᵣ(t), is changed according to the illumination of sunlight and the temperature, thus it can not be controlled. Secondly, the output voltage amplitude of the power distribution system 13, Vₚ, has very little variation and could not be controlled too, thus Vₚ can be viewed as a constant value in certain time period. Therefore, the output real power of the solar electricity generating system 1, pₛₒₗₐᵣ(t) is almost completely and directly proportional to the output current amplitude of the DC/AC converter 11, Iᵢₙᵥ. The unique technical features of the proposed method for tracking the maximum power point of the present invention are included in the following steps of: through adjusting the output current amplitude of the DC/AC converter 11, Iᵢₙᵥ, and sensing the direction of the variation of the output voltage of the solar cell 10, vₛₒₗₐᵣ (t), so as to decide the direction of adjustment of the output current amplitude, Iᵢₙᵥ, of the DC/AC converter 11 for the next round. There is no need to really calculate the output real power of the solar electricity generating system 1. For example, if the output current amplitude of the DC/AC converter 11, Iᵢₙᵥ, is adjusted larger and the DC output voltage of the solar cell 10, vₛₒₗₐᵣ (t), is increased, thus the output current amplitude of the DC/AC converter 11, Iᵢₙᵥ, can be increased continuously. Otherwise, if the output current amplitude of the DC/AC converter 11, Iᵢₙᵥ, is adjusted larger and the DC output voltage of the solar cell 10, vₛₒₗₐᵣ (t), is decreased, the output current amplitude of the DC/AC converter 11, Iᵢₙᵥ, should be decreased in the opposite direction. Finally, the DC output voltage of the solar cell 10, vₛₒₗₐᵣ (t), would be oscillated around the maximum power point of the solar electricity generating system 1.

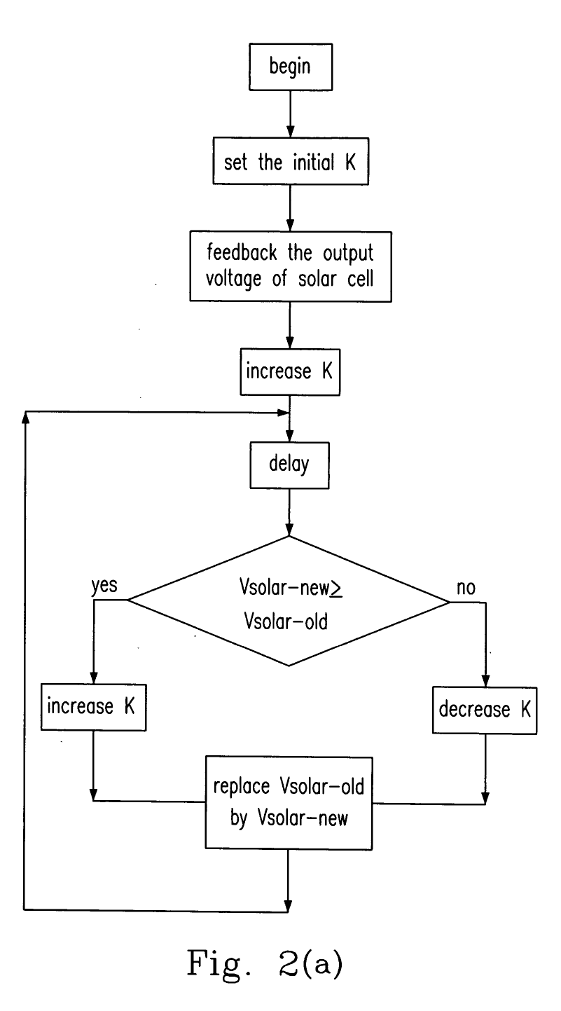

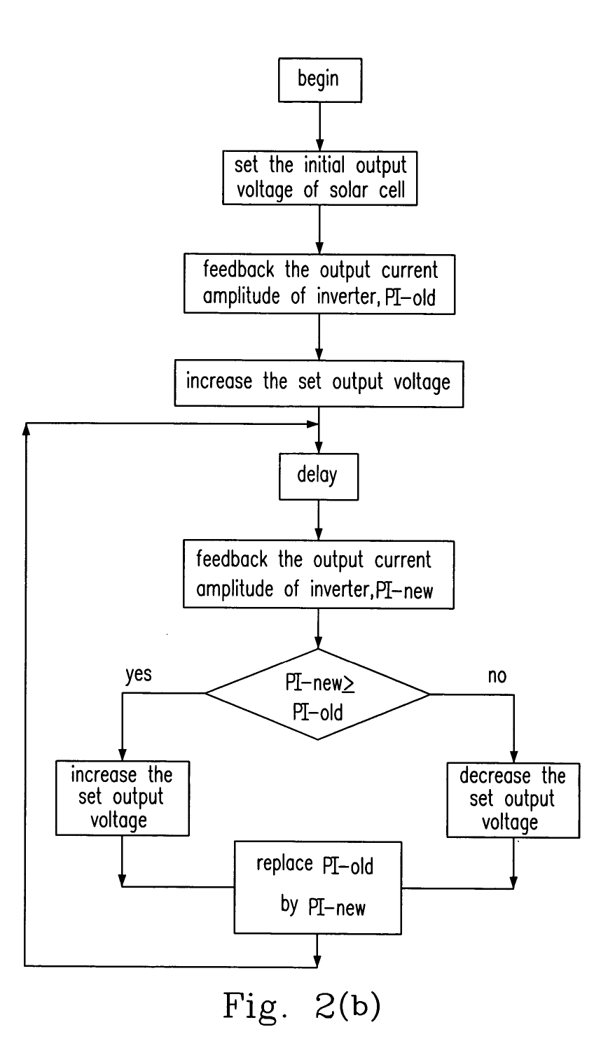

Please refer to FIG. 2(a), it is the flow chart of the first proposed method of the present invention for tracking the maximum power point of the solar electricity generating system 1 as shown in FIG. 1, which shows the invention concepts in a more practical way. In FIG. 2(a), the initial value of the output current amplitude of the DC/AC converter is set as K firstly. For the given K, the initial value of the DC output voltage of the solar cell, Vsolar-old, is feedback secondly. The output current amplitude of the DC/AC converter is increased to offer a new output current amplitude reference, which means to increase the value of K thirdly. Let the solar electricity generating system operate under this new value of K for a delayed time period fourthly. After the system is operated under the steady state, the DC output voltage of the solar cell, Vsolar-new, is sensed again fifthly. The result of comparing Vsolar-old with Vsolar-new will be employed to decide the direction of variation of the K value. If Vsolar-new>=Vsolar-old, K value is increased. Otherwise, if Vsolar-new<Vsolar-old, K value is decreased. After the new K value is decided, the Vsolar-old value is replaced by the Vsolar-new value sixthly. The same method is employed for the next round of sampling and comparison.

Besides, after the initial value of the output current amplitude of the DC/AC converter is set as K and the initial value of the DC output voltage of the solar cell is feedback, the maximum power point tracking method of the present invention as shown in FIG. 2(a) is not limited to increase the output current amplitude of the DC/AC converter (that is to increase the K value). Which means that the output current amplitude of the DC/AC converter, K, could be decreased to offer the output current amplitude reference (that is the “increase K value” block could be replaced by the “decrease K value” block). The important thing is that the K value is changed according to the variation direction of the Vsolar-new away from the Vsolar-old is the same in both cases since then.

In the proposed maximum power point tracking methods of the present invention, the operational principle of: adjusting the output current amplitude of the DC/AC converter according to the variation of the DC output voltage of the solar cell as shown in FIG. 2(a) could also be replaced by: adjusting the DC output voltage of the solar cell according to the output current amplitude variation of the DC/AC converter correspondingly as shown in FIG. 2(b). In the traditional maximum power point tracking techniques of the solar power, only the maximum power of the solar cell is calculated but not the power losses of the power converter. But the maximum power point tracking techniques of the present invention would track the whole solar electricity generating system, which means the maximum powers of both the electric power converter and the solar cell would be included, and the power losses of the electric power converter is considered. Please refer to FIG. 2(b), the initial value of the output voltage of the solar cell is set so as to decide the working voltage of the solar cell firstly. The initial value of the output current amplitude of the DC/AC converter, PI-old, is feedback secondly. The set DC output voltage is increased thirdly. Let the solar electricity generating system operate under this new value of DC output voltage for a delayed time period fourthly. After the system is operated under the steady state, the output current amplitude of the DC/AC converter, PI-new, is sensed again fifthly. The result of comparing PI-old with PI-new will be employed to decide the variation direction of the set DC output voltage of the solar cell. If PI-new>=PI-old, the set DC output voltage of the solar cell is increased. Otherwise, if PI-new<PI-old, the set DC output voltage of the solar cell is decreased. After the new set DC output voltage of the solar cell is decided, the PI-old value is replaced by the PI-new value sixthly. The same method is employed for the next round of sampling and comparison.

Worthy of mention is that the proposed maximum power point tracking methods for implementing in the operations of the real circuit could be applied to both configurations having a single converter stage or two converter stages.

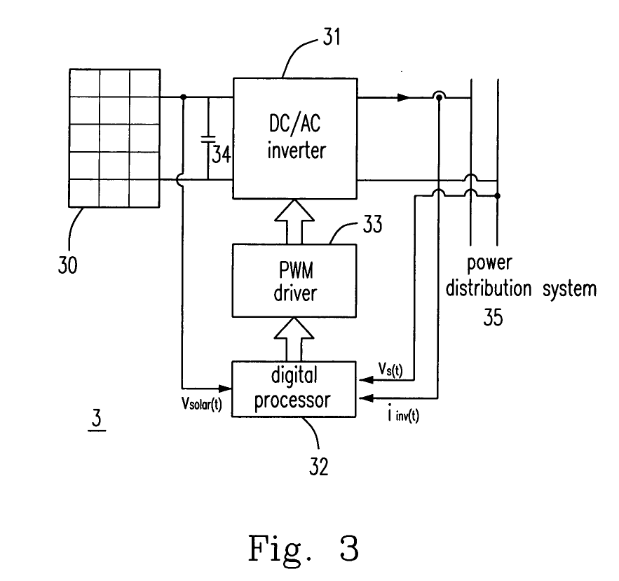

Please refer to FIG. 3, which is the block diagram of the second preferred embodiment of the solar electricity generating system having a single converter of the present invention. In which, the solar electricity generating system 3 includes: the solar cell 30, the DC/AC inverter 31, the digital processor 32, the pulse-width modulated driver (PWM driver) 33, and a capacitor 34. Among which, the DC output voltage of the solar cell 30 is transformed into the AC voltage through the capacitor 34 and the DC/AC inverter 31, and the AC voltage is sent back to the power distribution system 35.

To implement the maximum power point tracking method of the present invention, firstly the DC output voltage of the solar cell 30, vₛₒₗₐᵣ(t), the voltage of the power distribution system 35, vₛ(t), and the output current of the inverter 31, iᵢₙᵥ(t), are feedback to the digital processor 32 as shown in FIG. 3. Secondly, the PWM driver 33 is driven by the digital processor 32 to send out a PWM signal so as to control the DC/AC inverter 31 to generate different amplitudes of the output current, iᵢₙᵥ(t). Thirdly, the two sequential but different DC output voltages, vₛₒₗₐᵣ(t), generated according to different output current amplitudes of the inverter 31, Iᵢₙᵥ, of the solar cell 30 to decide the adjusting direction of the output current amplitude of the inverter 31, Iᵢₙᵥ, would be compared by the digital processor 32 to achieve the purpose of tracking the maximum power point of the solar cell 30.

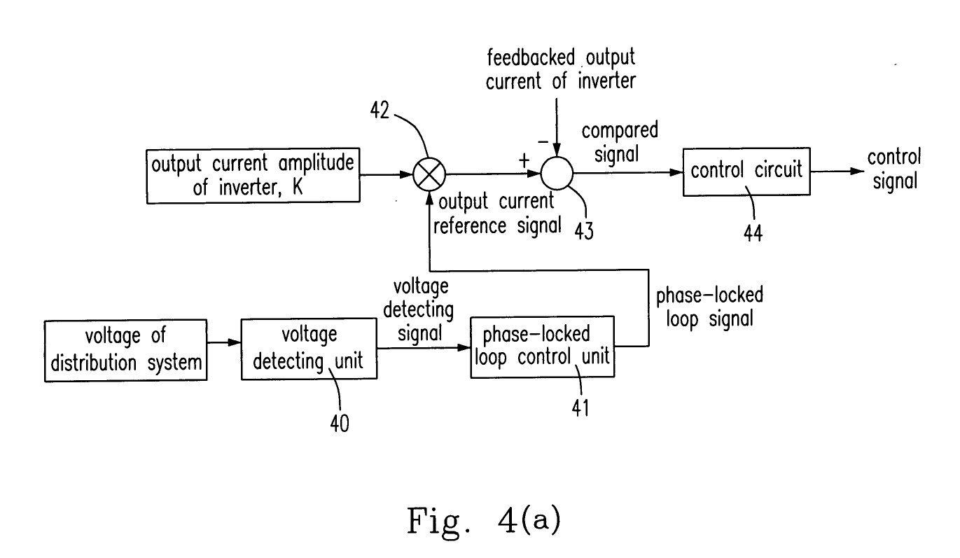

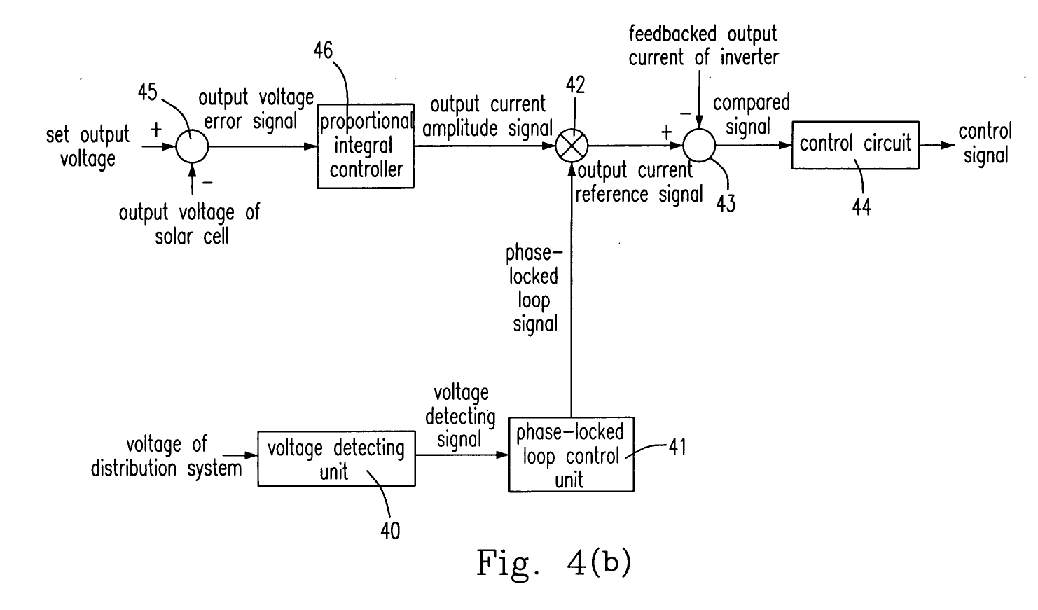

Besides, the implementing scheme of the digital processor 32 as shown in FIG. 3 could be further expressed using the configuration of FIG. 4(a) as an example, which adjusts the output voltage of the solar cell 30 according to the DC output current variation of the DC/AC inverter 31. In which, the feedback voltage of the power distribution system 35 is detected by the voltage-detecting unit 40 firstly, and a voltage detecting signal is generated by the voltage-detecting unit 40 secondly. A phase-locked loop signal having the same phase like the power distribution system and a sinusoidal waveform is generated by the phase-locked loop control unit 41, and the generated phase-locked loop signal is multiplied by the set value of output current amplitude of the inverter, K, through the multiplier 42 to get a output current reference signal thirdly. The feedback of the output current of the DC/AC inverter 31 is subtracted from the output current reference signal through a comparator 43 to generate a compared signal fourthly. The compared signal is sent to the control circuit 44 to generate the control signal for the DC/AC inverter 31 fifthly.

Furthermore, the maximum power point tracking method of the solar electricity generating system corresponding to that of FIG. 2(b), which adjusts the output voltage of the solar cell 30 according to the output current amplitude variation of the DC/AC inverter 31, the implementing scheme of the digital processor 32, as shown in FIG. 3, could be further expressed using the configuration of FIG. 4(b). In which, the feedback voltage of the power distribution system 35 is detected by the voltage-detecting unit 40 firstly, and a voltage detecting signal is generated by the voltage-detecting unit 40 secondly. A phase-locked loop signal having a phase identical to that of the power distribution system 35 and a sinusoidal waveform is generated by the phase-locked loop control unit 41 thirdly. Besides, the DC output voltage of the solar cell 30 is subtracted by a set output voltage through a comparator 45 to get a output voltage error signal fourthly. The output voltage error signal is processed by the proportional integral controller 46 to get an output current amplitude signal fifthly. Finally, the above-mentioned phase-locked loop signal is multiplied by the output current amplitude signal through the multiplier 42 to get an output current reference signal sixthly. The feedback of the output current of the DC/AC inverter 31 is subtracted from the output current reference signal through a comparator 43 to generate a compared signal seventhly. The compared signal is sent to the control circuit 44 to generate the control signal of the DC/AC inverter 31 eighthly.

In FIG. 4(b), the closed loop current control mode employed makes the output current of the inverter 31 approach the output current reference signal theoretically. The output of the proportional integral controller 46 is the output current amplitude reference signal of the inverter 31, thus the practical output current amplitude of the inverter 31 approaches the output of the proportional integral controller 46. Therefore, in the flow chart of the maximum power point tracking method as shown in FIG. 2(b), the output of the proportional integral controller 46 is employed as the output current amplitude of the inverter 31 to avoid the complex computation of the output current amplitude of the inverter 31.

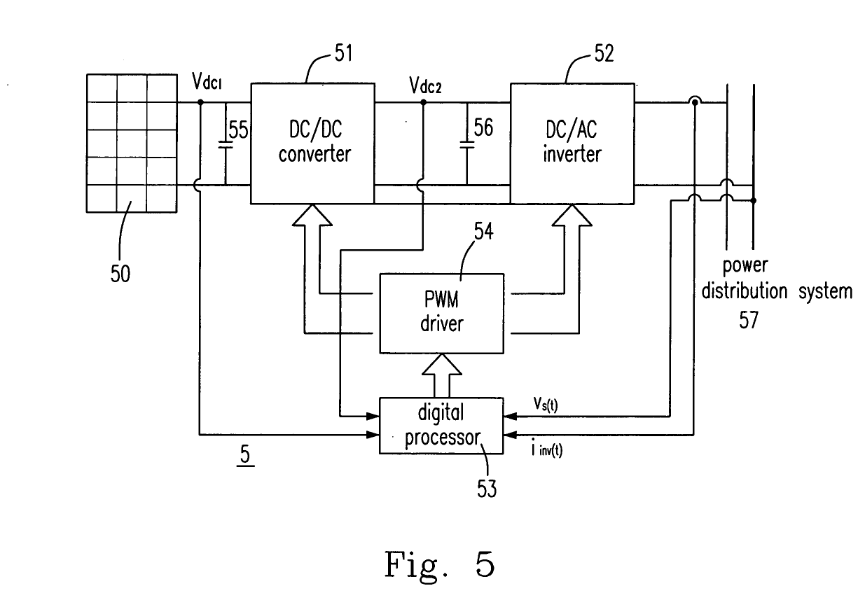

Please refer to FIG. 5, which is the block diagram of the third preferred embodiment of the solar electricity generating system having two converters of the present invention. In which, the solar electricity generating system 5 includes: the solar cell 50, the DC/DC converter 51, the DC/AC inverter 52, the digital processor 53, the PWM driver 54, and two capacitors 55 and 56. Different from the configuration having a single converter, the DC output voltage of the solar cell 50 is boosted to the level capable of matching with the voltage of the power distribution system 57 firstly, and is transformed into the AC voltage through the DC/AC inverter 52 and sent back to the power distribution system 57 secondly. Through the boosting of the DC/DC converter of the front stage, the DC/AC inverter 52 of the back stage could be operated more stably.

Due to the same scheme of changing the output current amplitude of the DC/AC inverter 52 and sensing the change of the DC output voltage of the solar cell 50 to decide the adjusting direction of the output current amplitude of the DC/AC inverter 52 is employed, the operational principles are the same as the configuration having the single converter. Thus the control methods of the DC/AC inverter of the configuration having the two converters of the solar electricity generating system 5 are the same as those of the configuration having the single converter, and the controlling flow chart and the configuration of the digital processor 53 are the same as those of FIGS. 2 and 4 as well respectively.

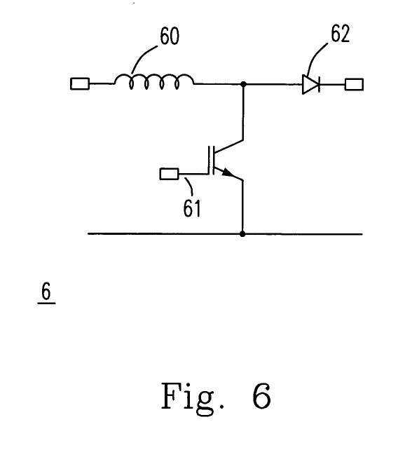

Also worthy of mention is that the DC/DC converter of the present invention could be a traditional boost converter as shown in FIG. 6. In which, the boost converter 6 includes the inductor 60, the power electronic switch 61, and the diode 62.

On the other hand, the control method of the digital processor 53 regarding the DC/DC converter 51 has two different ways: the fixed duty ratio and the fixed DC output voltage control methods, which are elaborated as follows.

The so-called fixed duty-ratio control method is to send out a fixed duty ratio pulse train directly by the digital processor 53 to control the power electronic switch 61 of the DC/DC converter 51 (or, the boost converter 6 of FIG. 6). Though the DC output voltage of the DC/DC converter 51 is changed following the variation of the DC output voltage of the solar cell 50, the DC output voltage can be boosted to the level capable of matching with the voltage of the power distribution system due to the inherent fixed boosting ratio of the DC/DC converter 51.

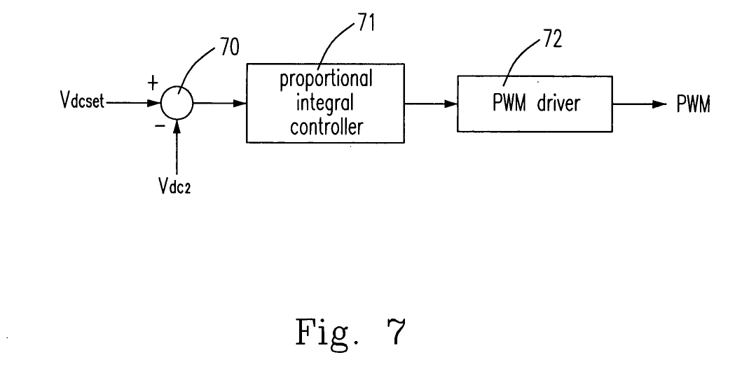

The so-called fixed DC output voltage control method is to employ a closed-loop control by the digital processor 53 to control the DC output voltage of the DC/DC converter 51 (or, the boost converter 6 of FIG. 6), and to make the DC output voltage be a fixed value, which would not be changed by following the DC output voltage variations of the solar cell 50. Please refer to FIG. 7, which is the block diagram of the fixed DC output voltage control method. The DC output voltage of the DC/DC converter, Vdc2, is compared with a pre-determined voltage, Vdcset, through a comparator 70 firstly. The-results of comparison are sent to the proportional integral controller 71 and the PWM driver 72 sequentially to produce a pulse train having the variable duty-ratio secondly. The pulse train is employed to control the power electronic switch 61 of the boost converter, and to make the DC output voltage of the DC/DC converter 51 be boosted to the level capable of matching the power distribution system 57.

Finally, corresponding to FIGS. 2(b) and 4(b), the proposed maximum power point tracking method, which adjusts the output voltage of the solar cell according to the variation of the output current amplitude of the DC/AC inverter, has the block diagram of the solar electricity generating system having two converters, the circuit of the DC/DC converter, and the block diagram of the fixed DC output voltage exactly the same as those of FIGS. 5-7.

In conclusion, the proposed maximum power point tracking methods and apparatuses are either adjusting the output current amplitude of the DC/AC converter and sensing the variation of the DC output voltage of the solar cell to decide the adjusting direction of the output current amplitude of the DC/AC converter for the next round accordingly, or adjusting the set DC output voltage of the solar cell and sensing the variation of the output current amplitude of the DC/AC converter to decide the adjusting direction of the DC output voltage of the solar cell for the next round accordingly. Both of these two maximum power point tracking methods can be applied to the configurations of having a single converter stage or two converter stages so as to achieve the purpose of tracking the maximum output power of the solar cell. The most important thing is that, the real circuit layout for applying the proposed maximum power point tracking methods of the present invention is simpler and thus the manufacturing and operational costs are lower relatively.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present invention which is defined by the appended claims.

1. A method for tracking a maximum power point of a solar electricity generating system, wherein said system comprises a solar cell and a DC/AC converter electrically connected to said cell, comprising the steps of:
(a) providing an initial value of an output current amplitude of said converter;
(b) sensing an initial value of an output voltage of said cell in response to said initial value of said output current amplitude;
(c) providing a reference output current amplitude of said converter and allowing said system being operated under said reference output current amplitude for a specific time period;
(d) sensing a output voltage of said cell in response to said reference output current amplitude;
(e) comparing said output voltage with said initial value of said output voltage to generate a variation of said output voltage;
(f) adjusting said reference output current amplitude in a direction of said variation and replacing said initial value of said output voltage by said reference output voltage; and
(g) repeating said steps (c) to (f).

2. A method for tracking a maximum power point of a solar electricity generating system, wherein said system comprises a solar cell and a DC/AC converter electrically connected to said cell, comprising the steps of:
(a) adjusting an output current of said converter;
(b) sensing an output voltage variation of said cell;
(c) adjusting said output current of said converter in a direction of said variation; and
(d) repeating said steps (a) to (c).

3. An apparatus for tracking a maximum power point of a solar electricity generating system, wherein said system comprises a solar cell and a DC/AC converter electrically connected to said cell, and an output voltage and an output current are generated by said cell and said converter respectively, comprising:
a digital processor electrically connected to said cell and said converter for receiving a feedback of said output voltage and a feedback of said output current, and generating a control signal in response to a variation of said output voltage; and
a driver electrically connected to said converter and said processor for generating a PWM signal in response to said control signal so as to adjust said output current amplitude in a direction of said variation of said output voltage.

4. The apparatus according to claim 3, further comprising a capacitor electrically connected to said cell and said converter in parallel.

5. The apparatus according to claim 3, wherein said converter is a DC/AC inverter.

6. The apparatus according to claim 3, wherein said processor comprises:
a voltage detecting unit for receiving a feedback voltage of a power distribution system electrically connected to said solar electricity generating system and generating a voltage detecting signal;
a phase-locked loop control unit for receiving said voltage detecting signal and generating a phase-locked loop signal;
a multiplier for multiplying said phase-locked loop signal by a pre-determined amplitude of said output current and generating a reference signal of said output current accordingly;
a comparator for subtracting said feedback of said output current from said reference signal of said output current so as to generate a compared signal, and
a control circuit for receiving said compared signal to generate a control signal.

7. An apparatus for tracking a maximum power point of a solar electricity generating system, wherein said system comprises a solar cell, a DC/DC converter electrically connected to said solar cell, and a DC/AC converter electrically connected to said DC/DC converter, and a first output voltage, a second output voltage, and an output current are generated by said cell, said DC/DC converter, and said DC/AC converter respectively, comprising:
a digital processor electrically connected to said cell, said DC/DC converter, and said DC/AC converter for receiving a feedback of said second output voltage and a feedback of said output current, and generating a control signal in response to a variation of said second output voltage; and
a driver electrically connected to the said processor and both the said DC/DC converter and said DC/AC converter for generating a PWM signals in response to said control signal so as to generate said second output voltage by said DC/DC converter and adjust an amplitude of said output current through said DC/AC converter in a direction of said variation of said second output voltage.

8. The apparatus according to claim 7, wherein said DC/DC converter is a boost converter for receiving and boosting said first output voltage to generate said second output voltage.

9. The apparatus according to claim 8, wherein said second output voltage is proportional to said first output voltage with a fixed ratio.

10. The apparatus according to claim 8, wherein said second output voltage has a fixed value.

11. The apparatus according to claim 7, wherein said DC/AC converter is a DC/AC inverter.

12. The apparatus according to claim 7, further comprising a first and a second capacitors, wherein said first capacitor is electrically connected to said cell and said DC/DC converter in parallel, and said second capacitor is electrically connected to said DC/DC and said DC/AC converters in parallel.

13. The apparatus according to claim 7, wherein said processor comprises:
a voltage detecting unit for receiving a feedback voltage of a power distribution system electrically connected to said solar electricity generating system and generating a voltage detecting signal;
a phase-locked loop control unit for receiving said voltage detecting signal and generating a phase-locked loop signal;
a multiplier for multiplying said phase-locked loop signal by a pre-determined amplitude of said output current and generating a reference signal of said output current accordingly;
a comparator for subtracting said feedback of said output current from said reference signal of said output current so as to generate a compared signal, and
a control circuit for receiving said compared signal to generate a control signal.

14. A method for tracking a maximum power point of a solar electricity generating system, wherein said system comprises a solar cell and a DC/AC converter electrically connected to said cell, comprising the steps of:
(a) providing an initial value of a DC output voltage of said cell;
(b) sensing an initial value of an output current amplitude of said converter in response to said initial value of said output voltage;
(c) providing a reference output voltage of said cell and allowing said system being operated under said reference output voltage for a specific time period;
(d) sensing a reference output current amplitude of said converter in response to said reference output voltage;
(e) comparing said reference output current amplitude with said initial value of said output current amplitude to generate an amplitude variation of said output current;
(f) adjusting said reference output voltage in a direction of said amplitude variation and replacing said initial value of said output current amplitude by said reference output current amplitude; and
(g) repeating said steps (c) to (f).

15. A method for tracking a maximum power point of a solar electricity generating system, wherein said system comprises a solar cell and a DC/AC converter electrically connected to said cell, comprising the steps of:
(a) adjusting a DC output voltage of said cell;
(b) sensing an output current amplitude variation of said converter;
(c) adjusting said output voltage in a direction of said variation; and
(d) repeating said steps (a) to (c).

16. An apparatus for tracking a maximum power point of a solar electricity generating system, wherein said system comprises a solar cell and a DC/AC converter electrically connected to said cell, and an output voltage and an output current are generated by said cell and said converter respectively, comprising:
a digital processor electrically connected to said cell and said converter for receiving a feedback of said output voltage and a feedback of said output current, and generating a control signal in response to an output current amplitude variation; and
a driver electrically connected to said converter and said processor for generating a PWM signal in response to said control signal so as to adjust said output voltage in a direction of said variation.

17. The apparatus according to claim 16, wherein said apparatus further comprises a capacitor electrically connected to said cell and said converter.

18. The apparatus according to claim 16, wherein said converter is a DC/AC inverter.

19. The apparatus according to claim 16, wherein said processor comprises:
a voltage detecting unit for receiving a feedback voltage of a power distribution system electrically connected to said solar electricity generating system and generating a voltage detecting signal;
a phase-locked loop control unit for receiving said voltage detecting signal and generating a phase-locked loop signal;
a first comparator for subtracting said feedback of said output voltage from a pre-determined voltage so as to generate an output voltage error signal;
a proportional integral controller for receiving said error signal so as to generate an output current amplitude signal;
a multiplier for multiplying said phase-locked loop signal by said amplitude signal and generating an output current reference signal accordingly; and
a second comparator for subtracting said feedback of said output current from said reference signal so as to generate a compared signal, and
a control circuit for receiving said compared signal to generate a control signal.

20. An apparatus for tracking a maximum power point of a solar electricity generating system, wherein said system comprises a solar cell, a DC/DC converter electrically connected to said solar cell, and a DC/AC converter electrically connected to said DC/DC converter, and a first output voltage, a second output voltage, and an output current are generated by said cell, said DC/DC converter, and said DC/AC converter respectively, comprising:
a digital processor electrically connected to said cell, said DC/DC converter, and said DC/AC converter for receiving a feedback of said second output voltage and a feedback of said output current, and generating a control signal in response to an output current amplitude variation; and
a driver electrically connected to said processor and both said DC/DC converter and said DC/AC converter for generating a PWM signals in response to said control signal so as to generate said second output voltage by said DC/DC converter and adjust said first output voltage through said cell in a direction of said variation.

21. The apparatus according to claim 20, wherein said DC/DC converter is a boost converter for receiving and boosting said first output voltage to generate said second output voltage.

22. The apparatus according to claim 21, wherein said second output voltage is proportional to said first output voltage with a fixed ratio.

23. The apparatus according to claim 21, wherein said second output voltage has a fixed value.

24. The apparatus according to claim 20, wherein said DC/AC converter is a DC/AC inverter.

25. The apparatus according to claim 20, further comprising a first and a second capacitors, wherein said first capacitor is electrically connected to said cell and said DC/DC converter in parallel, and said second capacitor is electrically connected to said DC/DC converter and said DC/AC converter in parallel.

26. The apparatus according to claim 20, wherein said processor comprises:
a voltage detecting unit for receiving a feedback voltage of a power distribution system electrically connected to said solar electricity generating system and generating a voltage detecting signal;
a phase-locked loop control unit for receiving said voltage detecting signal and generating a phase-locked loop signal;
a first comparator for subtracting said feedback of said second output voltage from a pre-determined voltage so as to generate an output voltage error signal;
a proportional integral controller for receiving said error signal so as to generate an output current amplitude signal;
a multiplier for multiplying said phase-locked loop signal by said amplitude signal and generating an output current reference signal accordingly; and
a second comparator for subtracting said feedback of said output current from said reference signal so as to generate a compared signal, and
a control circuit for receiving said compared signal to generate a control signal.
